(19) United States
(12) Patent Application Publication
(10) Pub. No.: US 2005/0200741 A1
(43) Pub. Date: Sep. 15, 2005

(54) Image photography apparatus and manufacturing method thereof

(75) Inventor: Kyoung-Jin Ahn, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/047,621

(22) Filed: Feb. 2, 2005

(30) Foreign Application Priority Data
Mar. 10, 2004 (KR) 2004-16021

(51) Int. Cl. H04N 5/225

(52) U.S. Cl. 348/335

(57) ABSTRACT

An image photography apparatus and method are provided. The apparatus and method include: a board for performing a predetermined function in an interior portion of the apparatus; and a camera unit having a lens, connected to the board so that electrical signal exchange is possible, wherein a reference plane, virtual plane perpendicular to an optical axis of the lens, and a plane of the board, are substantially perpendicular to each other.

### PRIORITY

This application claims the benefit under 35 U.S.C. § 119(a) of Korean Patent Application No. 2004-16021, filed on Mar. 10, 2004, the entire disclosure of which is incorporated herein by reference.

### BACKGROUND OF THE INVENTION

1. Field of the Invention

The present invention relates to an image photography apparatus and method of manufacturing the same that is capable of photographing an image including a moving image and a still image, and storing and playing the same.

2. Description of the Related Art

A digital still camera (DSC) converts an image provided through a lens, into a digital signal, and stores the digital signal in a recording media such as a hard disk or a memory card. The digital still camera can store a photographed image on the recording media and therefore, does not require a film, and provides the photographed image in a digital format to a computer. Since such a digital still camera has a high compatibility with an external computer system, editing and modification of the image are easy, and the digital still camera can be connected to the external computer system, so that the photographed image may be transferred. However, such a digital still camera is mainly used for photographing a still image due to the limited capacity of the recording media for recording an image. Some DSCs can perform a video recording function for a limited duration. However, since an apparatus for recording a moving image and a sound, and playing the same simultaneously upon play back, should be additionally provided to properly record a moving image, the DSC is substantially inappropriate for recording, storing, and playing a moving image. Therefore, to record a moving image, a recording/playing apparatus for recording an image and a sound onto the recording media such as a tape, and playing the same, is required. A camcorder is typically used to accomplish this.

The camcorder, which mainly uses a cassette tape for the recording media, mounts the cassette tape in its deck and records a moving image. The camcorder also has a microphone and a speaker. Such a camcorder can photograph a still image, but the image quality of that still image is poor when compared to that of the still image photographed by the above-described stand-alone still camera. Therefore, the camcorder is mainly used for photographing a moving image. Since the camcorder has more functions than the DSC and therefore has a complicated construction, the camcorder generally is relatively large and high-priced.

Up to now, as described above, to use each function of the DSC and the camcorder and provide good quality images, the two products should be purchased separately. Therefore, there is a financial burden on users, and because the two products should be carried together in order to capture both still images and moving images, it has been quite inconvenient. Recently, to solve this problem, a product where the function of the DSC and the function of the camcorder, i.e., the apparatus for photographing a still image and the apparatus for photographing a moving image are incorporated into one single product so that a user may selectively use the desired function when necessary, has been developed and sold. A dual cam is one of such products.

However, in the dual cam, since the two functions are incorporated into one single product, problems are encountered such as the product size increases and the structure gets more complicated. In the dual cam, a digital still camera lens for photographing a still image and a digital video camera (DVC) lens for recording a moving image should be arranged together in a narrow space. Particularly, depending on utilization of a space between the digital still camera lens and the board for performing signal transfer to and from the digital still camera, the product size is determined. According to the conventional art, the digital still camera lens and the board thereof are arranged horizontally (that is, an optical axis of the lens and a plane of the board are arranged perpendicularly). In that case, a problem is encountered in that the volume of the dual cam increases. Therefore, an arrangement structure between the digital still camera lens and the board to reduce overall apparatus size is needed.

### SUMMARY OF THE INVENTION

The present invention has been developed in order to solve the above drawbacks and other problems associated with the conventional art. Therefore, an object of the present invention is to provide an image photography apparatus and method capable of realizing a compactness of the product through efficient arrangement of the digital still camera lens and the board.

To achieve the above object and other advantages, there is provided an image photography apparatus and manufacturing method, wherein a board for performing a predetermined function in the interior of the apparatus and a camera unit including a lens connected to the board so that an electrical signal exchange is possible, are provided, and a reference plane which is a virtual plane perpendicular to an optical axis of the lens, and a plane of the board are substantially perpendicular to each other.

Also, the camera unit is preferably arranged on one corner side of the board, and the camera unit is arranged at the lower end of the board.

Also, the camera unit is preferably directly joined to the board and one corner side of the camera unit is joined to the board.

### BRIEF DESCRIPTION OF THE DRAWINGS

The above aspects and features of the present invention will be more apparent by describing exemplary embodiments of the present invention with reference to the accompanying drawings, in which:

FIG. 1 is a perspective view of an image photography apparatus according to an embodiment of the present invention;

FIG. 2 is an exploded, perspective view of FIG. 1;

FIG. 3 is a perspective view of a sub board and a second camera unit assembly without a second outer casing in a second outer assembly according to an embodiment of the present invention;

FIG. 4 is a perspective view of FIG. 3, seen from the other side; and

FIG. 5 is a drawing showing a structural relationship between a sub board and a second camera unit according to an embodiment of the present invention.

The same drawing reference numerals are used for the same elements throughout the drawings.

### DETAILED DESCRIPTION OF EXEMPLARY EMBODIMENTS

The construction and operation of exemplary embodiments of the present invention will now be described in greater detail with reference to the accompanying drawings.

The matters defined in the description such as a detailed construction and elements are exemplary. Thus, it should be apparent that the embodiments of the present invention can be performed without the specific examples. Also, well-known functions or constructions are omitted conciseness.

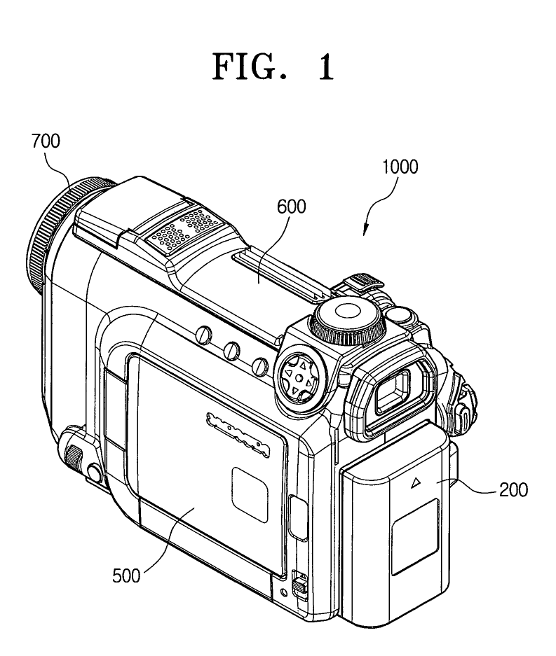

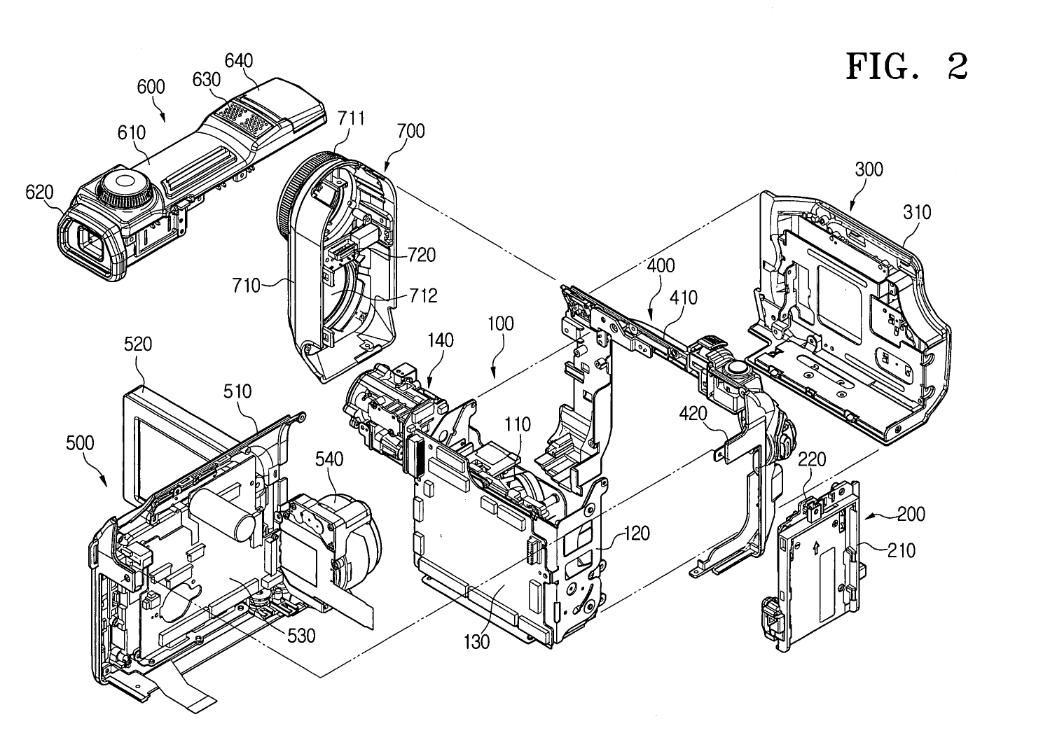

As shown in FIGS. 1 and 2, the image photography apparatus 1000 has a deck assembly 100; a rear assembly 200; a first outer assembly 300; a deck cover assembly 400; a second outer assembly 500; an upper assembly 600; and a front assembly 700.

The deck assembly 100 has a deck unit 110 for recording data including an image and playing the data recorded on a magnetic tape; a deck housing 120 for enclosing and supporting the deck unit 110; a main board 130 installed to correspond to the deck unit 110 and electrically connected to the deck unit 120 and a first camera unit 140 so that mutual signal transfer is possible. The first camera unit 140 is a conventional digital video camera (DVC) for obtaining a moving image.

The rear assembly 200 is fixed at the deck housing 120 by means of a screw, and has a rear casing 210 and a rear board 220 joined to the inside of the rear casing 210.

The first outer assembly 300 is joined to cover one side of the deck assembly 100, for example, to cover a part of its right side, and has a first outer casing 310 which is formed by molding. A zoom knob (not shown) for adjusting a focal length up to a subject; a photo-shutter (not shown) for photographing a still image; a mode selection switch (not shown) for selecting between a moving image photographing mode or a still image photographing mode; and a recording button (not shown), are installed on the first outer casing 310.

The deck cover assembly 400 has a cover casing 410 which is formed by molding and; a supporting frame 420 joined to the inside of the cover casing 410.

The second outer assembly 500 has a second outer casing 510; a first display unit 520 joined to the outside of a second outer assembly 510; a sub board 530; and a second camera unit 540.

The second outer casing 510 encloses the left side of the deck assembly 100, or the side of the main board 130. The second outer casing 510, which is preferably made of plastic material by a molding process, has a display mounting part (not shown) on its outside. The first display unit 520 is received and mounted on the display mounting part. Also, a roll switch (not shown) for selecting a menu, a plurality of connection ports (not shown) for connecting with an external apparatus, a speaker unit (not shown), a plurality of function keys, are installed on the second outer casing 510. Additionally, a variety of function keys may be installed on the second outer casing 510.

The first display unit 520 is preferably an Liquid Crystal Display (LCD) panel and rotatable with respect to two axes, on the second outer casing 510, through which an image photographed by the first and the second camera units 140 and 540 or the playback image is displayed. The first display unit 520 is electrically connected to the sub board 530 by means of a cable.

The sub board 530 is joined to the inside of the second outer casing 510. Through the sub board 530, the first display unit 520 and the second camera unit 540 are electrically connected. Also, when the first outer assembly 500 is joined to the deck assembly 100, the sub board 530 is joined to the main board 130 by means of a signal cable. Such a sub board 530 is arranged to be approximately in parallel with the main board 130. Also, the above-described roll switch, connection ports, speaker unit and function keys are electrically connected to the sub board 530.

The second camera unit 540 is a digital still camera (DSC) used mainly for photographing a still image. The second camera unit 540 has a Charge-Coupled Device (CCD) whose pixels are greater in number than those of the first camera unit 140 so that it can obtain an image of high quality.

The upper assembly 600 has an upper casing 610 for covering an upper part of the deck assembly 100; a viewfinder unit 620 assembled at one end of the upper casing 610 and which makes it possible for a user to view, with a natural eye, an image photographed or played by the first camera unit 140 or the second camera unit 540; a microphone unit 630 joined to the upper casing 610 in a projecting manner toward the outside; and a flash unit 640. The viewfinder unit 620, the microphone unit 630, and the flash unit 640 are electrically connected to the sub board 530. Also, a variety of function-key modules (not shown) for performing the functions of the DSC that uses the second camera unit 540, is installed on the upper casing 610, and the function-key module is electrically connected to the sub board 530.

The front assembly 700, which is designed to cover the front side of the apparatus on which the first and the second camera units 140 and 540 are arranged, has a front casing 710 having a first lens hood and a second lens hood which are open toward the first and the second camera units 140 and 540, respectively; and a sensor module 720 supported at the inside of the front casing 710 and having a remote control sensor and an illuminating sensor not shown.

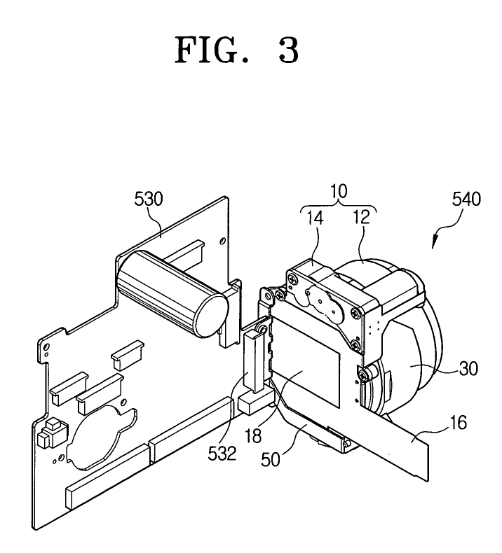

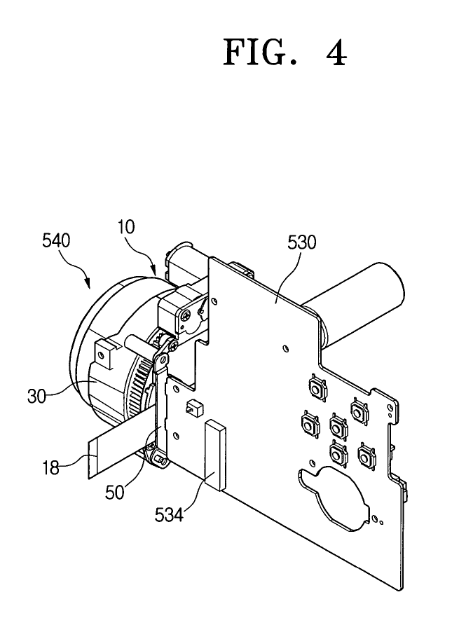

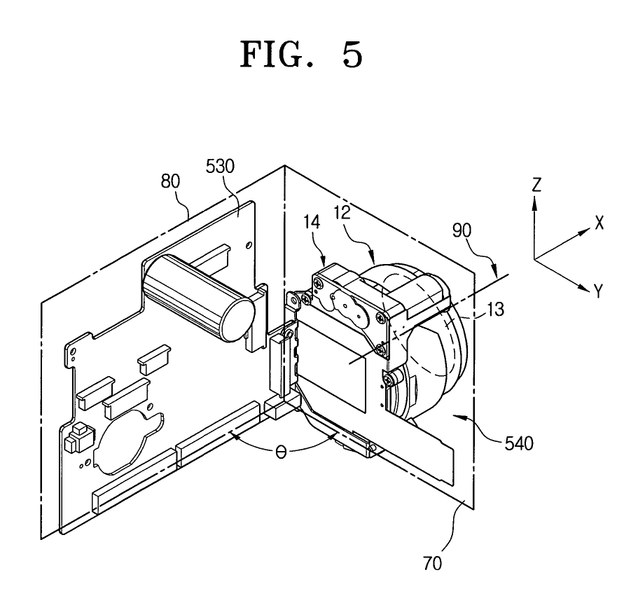

FIG. 3 shows an assembly structure of the second camera unit 540 and the sub board 530 in the second outer assembly 500 of FIG. 2, and FIG. 4 is a perspective view of FIG. 3, seen from the other side, and FIG. 5 shows a structural relationship between the second camera unit 540 and the sub board 530. As shown in FIGS. 3, 4, and 5, the second camera unit 540 is connected, joined, and installed so that the signal transfer to and from the sub board 530 may be possible.

Like the conventional digital still camera lens module, the second camera unit 540 includes a lens module 10 having a casing 12 which houses therein a lens 13 (see FIG. 5) and a CCD (not shown), a motor 14, signal cables 16 and 18 of the CCD and the motor 14; a holder 30 for enclosing the outer periphery of the casing 12; and a bracket 50 screw-joined to the holder 30. As shown in the drawings, the second camera unit 540 is joined to the sub board 530 by means of the bracket 50.

Also, signal cables 16 and 18 for transferring an electrical signal of the CCD to the sub board 530, is mounted on the backside of the motor 14 of the lens module 10. The motor signal cable 16 is connected to the connector 532 installed on the front side of the sub board 530, and the CCD signal cable 18 is connected to the connector 534 installed on the backside of the sub board 530, whereby signal transfers to and from the sub board 530 become possible. As described above, the sub board 530 is connected to the connector installed on the main board 130 by means of the connector and a separate signal cable, so that electrical signal transfers to and from the main board 130 become possible.

Referring to FIG. 5, a virtual plane 70, which is a Y-Z plane, is substantially perpendicular to an optical axis 90 formed at the center of the lens 13 of the lens module 10, and may be substantially perpendicular in relation to the plane 80, which is a Z-X plane, of the board. When the Y-Z plane and the Z-X plane are in substantially perpendicular relation with each other as described above, a compactness of the image photography apparatus can be realized because in the exemplary dual cam, which requires the deck assembly 100 (FIG. 1) to photograph, store, and play still and moving images, the deck assembly 100 can be arranged in the space formed by the camera unit 540 and the sub board 530.

With the conventional structure where the plane perpendicular to the optical axis of the conventional digital still camera lens and the plane of the board capable of performing signal transfers to and from the digital still camera lens, are arranged in parallel structure, there has been limitations in reducing the volume of the image photography apparatus. However, by making the camera unit 540 and the sub board of embodiments of the present invention arranged as described above, compactness of the image photography apparatus can be achieved.

To make more efficient use of the space between the camera unit 540 and the sub board 530, one side of the second camera unit 540 may be arranged and joined to one corner side of the sub board 530 as shown in FIGS. 2 through 4. Also, when the second outer assembly 500 and the deck assembly 100 are mutually assembled, the second camera unit 540 is joined to the lower end of the sub board 530 so that it can be arranged below the first camera unit 140. Accordingly, the second camera unit 540 is installed in the lower part of the first camera unit 140 as shown in FIG. 2. As described above, one corner side of the second camera unit 540 is joined to the lower end and one corner side of the sub board 530, and as a result, the deck assembly 100 is positioned on the space secured therein. Therefore, compactness of the image photography apparatus according to the present invention is accomplished.

Although the present invention has been described in relation to the arrangement structure between the camera unit and the sub board, the invention is not limited to that specific embodiment, but applied to any arrangement structure as far as it is an arrangement structure between the camera unit and any board for exchanging signal to and from the camera unit among a plurality of boards of the image photography apparatus.

As is apparent from the foregoing, according to the image photography apparatus of the present invention, the space in the interior of the image photography apparatus is effectively used, so that compactness of the product is resultantly realized.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. An image photography apparatus comprising:
a board installed in an interior portion of the apparatus; and
a camera unit including a lens, connected with the board so that electrical signal exchange occurs,
wherein a reference plane, which is a virtual plane perpendicular to an optical axis of the lens, and a plane of the board, are arranged to be substantially perpendicular to each other.

2. The apparatus according to claim 1, wherein the camera unit is joined to an edge of the board.

3. The apparatus according to claim 2, wherein an edge of the camera unit is joined to the edge of the board.

4. The apparatus according to claim 1, wherein the camera unit is joined to a lower end of the board.

5. The apparatus according to claim 4, wherein an edge of the camera unit is joined to the lower end of the board.

6. An image photography apparatus comprising:
a digital still camera unit;
a digital video camera unit;
a deck unit; and
a plurality of boards for performing a predetermined function in an interior portion of the apparatus,
wherein a reference plane which is a virtual plane substantially perpendicular to an optical axis of a lens of the digital still camera unit, and a plane of at least one board among a plurality of the boards, connected with the digital still camera unit so that electrical signal exchange occurs, are substantially perpendicular to each other.

7. The image photography apparatus of claim 6, wherein the plurality of boards comprise a main board and a sub-board.

8. The image photography apparatus of claim 6, wherein the digital still camera captures still images.

9. The image photography apparatus of claim 6, wherein the digital still camera comprises a charge coupled device (CCD).

10. The image photography apparatus of claim 6, wherein the digital video camera captures moving images.

11. The image photography apparatus of claim 6, further comprising:
a display unit for displaying the images captured by the digital still camera and the digital video camera of the image photography apparatus.

12. The image photography apparatus of claim 11, wherein the display comprises a liquid crystal display.

13. The image photography apparatus of claim 6, wherein the deck unit is disposed between the digital still camera unit and the at least one board among a plurality of the boards.

14. The image photography apparatus of claim 7, wherein the main board and the sub-board are joined via a signal cable.

15. A method of reducing a size of a dual camera apparatus, comprising:
installing a board in an interior portion of the apparatus; and
connecting a camera unit including a lens to the board so that electrical signal exchange occurs, wherein a reference plane, which is a virtual plane perpendicular to an optical axis of the lens, and a plane of the board, are arranged to be substantially perpendicular to each other.

16. The method of claim 15, wherein the dual camera apparatus includes a digital still camera and a digital video camera.

17. The method of claim 16, wherein the digital still camera captures still images.

18. The method of claim 16, wherein the digital video camera captures moving images.

19. The method of claim 15, further comprising:
connecting a sub-board to the board via an electrical cable.
